(19) United States
(12) Patent Application Publication
(10) Pub. No.: US 2026/0270263 A1
(43) Pub. Date: Sep. 10, 2026

(54) METHOD, APPARATUS AND SYSTEM FOR MANAGING CLUSTER ACCESS PERMISSION

(71) Applicant: JINGDONG TECHNOLOGY INFORMATION TECHNOLOGY CO., LTD., Beijing (CN)

(72) Inventors: Kun WANG, Beijing (CN); Jianxing ZHAO, Beijing (CN); Jiangang FAN, Beijing (CN)

(21) Appl. No.: 18/873,694

(22) PCT Filed: Apr. 21, 2023
(86) PCT No.: PCT/CN2023/089635

§ 371 Date: Dec. 10, 2024

(30) Foreign Application Priority Data
Sep. 1, 2022 (CN) 202211064945.0

(51) Int. Cl. H04L 9/40

(52) U.S. Cl. CPC H04L 63/10

(57) ABSTRACT

The disclosure provides a method, apparatus and system for managing a cluster access permission, an electronic device and a computer-readable medium. The disclosure relates to the technical field of cloud computing. A specific implementation scheme of the method comprises: automatically acquiring an access permission policy of a first cluster managed in a plurality of clusters; and acquiring access permission information between the first cluster and one or more second clusters associated therewith that is included in the access permission policy; automatically updating, in a case where it is monitored that resources of the one or more second clusters have changed, the access permission information included in the access permission policy; dynamically managing the plurality of clusters by using the updated access permission information.

### CROSS REFERENCE TO RELATED APPLICATIONS

The application claims priority to CN Patent Application No. 202211064945.0, entitled “Method, Apparatus and System for Managing Cluster Access Permission”, which was filed on Sep. 1, 2022, and the contents of which are hereby incorporated by reference in its entirety to serve as part or all of the application.

### TECHNICAL FIELD

The disclosure relates to the technical field of cloud computing, and in particular relates to a method, apparatus and system for managing a cluster access permission.

### BACKGROUND

Data interaction between a plurality of clusters may generally be used to improve data processing capabilities of Internet application systems. In accordance with the service scenario of the application, it is generally required to manage an access permission between clusters when processing the data interaction between the clusters. The current method for processing the access permission between the clusters is to perform a respective configuration for each cluster requiring interaction in accordance with a set interactive access permission (such as black and white lists).

### SUMMARY OF THE INVENTION

In accordance with one or more embodiments of the disclosure, a method for managing a cluster access permission is provided, characterized in that the method comprises: acquiring an access permission policy of a first cluster; the access permission policy including access permission information between the first cluster and one or more second clusters associated therewith; updating, in a case where it is monitored that resources of any of the associated second clusters have changed, the access permission information corresponding to the second cluster that is included in the access permission policy in accordance with a change result of the resources of the second cluster; managing the access permission between the first cluster and the second cluster associated therewith by using the updated access permission policy.

In accordance with one or more embodiments of the disclosure, the method for managing a cluster access permission further comprises: updating, in a case where it is monitored that resources of the first cluster have changed, the access permission information corresponding to the first cluster that is included in the access permission policy in accordance with a change result of the resources of the first cluster; managing the access permission between the first cluster and the second cluster associated therewith by using the updated access permission policy.

In accordance with one or more embodiments of the disclosure, the step of updating the access permission information corresponding to the second cluster that is included in the access permission policy comprises: adding an annotation including a cluster identifier of the second cluster to the access permission information corresponding to the second cluster; indicating a case where the resources of the second cluster have changed by means of the cluster identifier included in the annotation, so as to limit the access permission of the first cluster to access the second cluster by combining the access permission policy with the annotation in a case where the first cluster accesses the second cluster.

In accordance with one or more embodiments of the disclosure, the step of acquiring an access permission policy of a first cluster comprises: acquiring configuration information of the first cluster; determining cluster information of the one or more second clusters associated with the first cluster in accordance with the configuration information; acquiring preset access permission information between the first cluster and the one or more second clusters, and generating the access permission policy of the first cluster based on the preset access permission information.

In accordance with one or more embodiments of the disclosure, the step of acquiring preset access permission information between the first cluster and the one or more second clusters comprises: parsing the preset access permission information from a preset configuration file, and/or parsing the preset access permission information from custom permission data included in the first cluster, wherein the custom permission data is obtained based on extension of native permission data of the cluster.

In accordance with one or more embodiments of the disclosure, the method for managing a cluster access permission further comprises: the first cluster including a permission controller; performing the steps of acquiring the access permission policy of the first cluster and updating the access permission policy by using the permission controller.

In accordance with one or more embodiments of the disclosure, the method for managing a cluster access permission further comprises: starting a first controller and a second controller for the first cluster to which the permission controller belongs by using the permission controller; monitoring a resource change of the first cluster by using the first controller; monitoring a resource change of the one or more second clusters associated with the first cluster by using the second controller.

In accordance with one or more embodiments of the disclosure, according to a second aspect of the embodiments of the disclosure, an apparatus for managing a cluster access permission is provided, the apparatus comprising: a policy acquiring module, a permission changing module and a permission managing module; wherein
the policy acquiring module is used for acquiring an access permission policy of a first cluster; the access permission policy including access permission information between the first cluster and one or more second clusters associated therewith;
the permission changing module is used for updating, in a case where it is monitored that resources of any of the associated second clusters have changed, the access permission information corresponding to the second cluster that is included in the access permission policy in accordance with a change result of the resources of the second cluster;
the permission managing module is used for managing the access permission between the first cluster and the second cluster associated therewith by using the updated access permission policy.

In accordance with one or more embodiments of the disclosure, the apparatus for managing a cluster access permission is further used for updating, in a case where it is monitored that resources of the first cluster have changed, the access permission information corresponding to the first cluster that is included in the access permission policy in accordance with a change result of the resources of the first cluster; managing the access permission between the first cluster and the second cluster associated therewith by using the updated access permission policy.

In accordance with one or more embodiments of the disclosure, the apparatus for managing a cluster access permission is used for updating the access permission information corresponding to the second cluster that is included in the access permission policy, which comprises: adding an annotation including a cluster identifier of the second cluster to the access permission information corresponding to the second cluster; indicating a case where the resources of the second cluster have changed by means of the cluster identifier included in the annotation, so as to limit the access permission of the first cluster to access the second cluster by combining the access permission policy with the annotation in a case where the first cluster accesses the second cluster.

In accordance with one or more embodiments of the disclosure, the apparatus for managing a cluster access permission is used for acquiring an access permission policy of a first cluster, which comprises: acquiring configuration information of the first cluster; determining cluster information of the one or more second clusters associated with the first cluster in accordance with the configuration information; acquiring preset access permission information between the first cluster and the one or more second clusters, and generating the access permission policy of the first cluster based on the preset access permission information.

In accordance with one or more embodiments of the disclosure, the apparatus for managing a cluster access permission is used for acquiring preset access permission information between the first cluster and the one or more second clusters, which comprises: parsing the preset access permission information from a preset configuration file, and/or parsing the preset access permission information from custom permission data included in the first cluster, wherein the custom permission data is obtained based on extension of native permission data of the cluster.

In accordance with one or more embodiments of the disclosure, the apparatus for managing a cluster access permission is further used for: the first cluster including a permission controller; performing the steps of acquiring the access permission policy of the first cluster and updating the access permission policy by using the permission controller.

In accordance with one or more embodiments of the disclosure, the apparatus for managing a cluster access permission is further used for: starting a first controller and a second controller for the first cluster to which the permission controller belongs by using the permission controller; monitoring a resource change of the first cluster by using the first controller; monitoring a resource change of the one or more second clusters associated with the first cluster by using the second controller.

In accordance with one or more embodiments of the disclosure, an apparatus for managing a cluster access permission is provided, the apparatus comprising: a policy acquiring module, a permission changing module and a permission managing module; wherein
the policy acquiring module is used for acquiring an access permission policy of a first cluster; the access permission policy including access permission information between the first cluster and one or more second clusters associated therewith;
the permission changing module is used for updating, in a case where it is monitored that resources of the first cluster have changed, the access permission information corresponding to the first cluster that is included in the access permission policy in accordance with a change result of the resources of the first cluster;
the permission managing module is used for managing the access permission between the first cluster and the second cluster associated therewith by using the updated access permission policy.

In accordance with one or more embodiments of the disclosure, a system for managing a cluster access permission is provided, characterized in that the system comprises: a plurality of communicatively connected clusters; wherein the apparatus for managing a cluster access permission according to the second aspect or the apparatus for managing a cluster access permission according to the third aspect is configured in the one or more clusters.

In accordance with one or more embodiments of the disclosure, an electronic device for managing a cluster access permission is provided, characterized in that the electronic device comprises: one or more processors; a storage means for storing one or more programs, the one or more programs, when executed by the one or more processors, causing the one or more processors to implement the method of any of the aforesaid methods for managing a cluster access permission.

In accordance with one or more embodiments of the disclosure, a computer-readable medium is provided, on which medium a computer program is stored, characterized in that the program, when executed by a processor, implements the method of any of the aforesaid methods for managing a cluster access permission.

The embodiments of the disclosure have the following advantages or beneficial effects: being capable of automatically acquiring an access permission policy of a first cluster managed in a plurality of clusters; and acquiring access permission information between the first cluster and one or more second clusters associated therewith that is included in the access permission policy; automatically updating, in a case where it is monitored that resources of the one or more second clusters have changed, the access permission information included in the access permission policy; dynamically managing the plurality of clusters by using the updated access permission information. The method of the embodiments of the disclosure overcomes the problem of a comparatively poor flexibility in managing a cluster access permission in the existing method, and improves the real-time performance and efficiency of managing a cluster access permission.

Further effects of the aforesaid non-conventional optional manners will be described below in combination with specific implementation schemes.

### BRIEF DESCRIPTION OF THE DRAWINGS

Figures are used for better understanding of the disclosure, and do not form improper limitations of the disclosure. Wherein:

FIG. 1 is a schematic diagram of a flow of a method for managing a cluster access permission provided by one embodiment of the disclosure;

FIG. 2 is a schematic diagram of a managed cluster structure provided by one embodiment of the disclosure;

FIG. 3 is a schematic diagram of a flow for managing a cluster access permission provided by one embodiment of the disclosure;

FIG. 4 is a schematic diagram of a structure of an apparatus for managing a cluster access permission provided by one embodiment of the disclosure;

FIG. 5 is a schematic diagram of a structure of a system for managing a cluster access permission provided by one embodiment of the disclosure;

FIG. 6 is an exemplary diagram of a system architecture to which an embodiment of the disclosure can be applied;

FIG. 7 is a schematic diagram of a structure of a computer system suitable for implementing a terminal device or a server according to an embodiment of the disclosure.

### DETAILED DESCRIPTION

The exemplary embodiments of the disclosure, including various details of the embodiments of the disclosure, are described below in combination with the figures to facilitate understanding, and shall be considered to be exemplary ones only. Thus, those skilled in the art should recognize that various changes and modifications may be made to the embodiments described herein without departing from the scope and spirit of the disclosure. Similarly, for clarity and conciseness, descriptions of well-known functions and structures are omitted in the descriptions below.

The embodiments of the disclosure provide a method, apparatus and system for managing a cluster access permission, and are capable of automatically acquiring an access permission policy of a first cluster managed in a plurality of clusters; and acquiring access permission information between the first cluster and one or more second clusters associated therewith that is included in the access permission policy; automatically updating, in a case where it is monitored that resources of the one or more second clusters have changed, the access permission information included in the access permission policy; dynamically managing the plurality of clusters by using the updated access permission information. The method of the embodiments of the disclosure overcomes the problem of a comparatively poor flexibility in managing a cluster access permission in the existing method, and improves the real-time performance and efficiency of managing a cluster access permission.

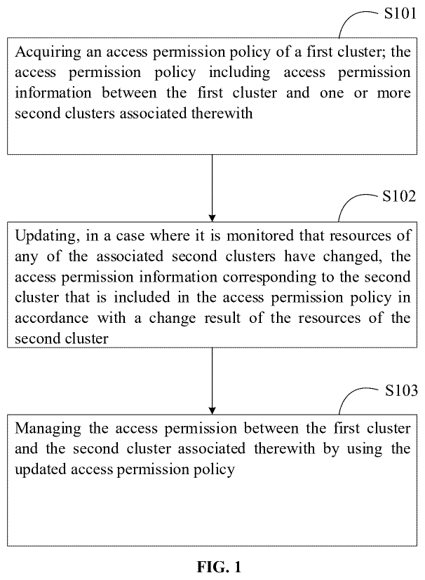

As shown in FIG. 1, the embodiments of the disclosure provide a method for managing a cluster access permission, and the method may comprise the following steps:

Step S101: acquiring an access permission policy of a first cluster; the access permission policy including access permission information between the first cluster and one or more second clusters associated therewith.

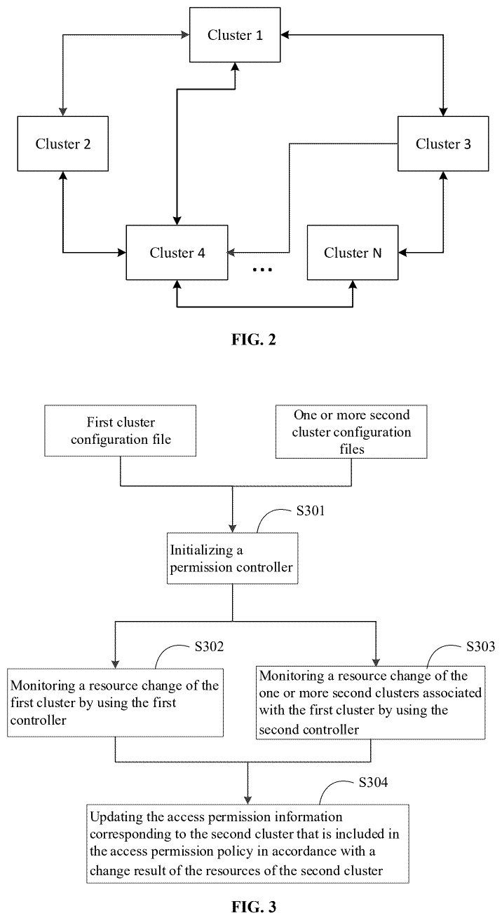

Specifically, in one embodiment of the disclosure, the method for managing a cluster access permission may be used for any of a plurality of clusters managed. FIG. 2 shows a plurality of clusters with data interaction: cluster 1, cluster 2 . . . cluster N. As shown in FIG. 2, with respect to cluster 1, cluster 1 has an association relationship (such as data interaction, or data synchronization, between each other, etc.) with cluster 2, cluster 3 and cluster 4, so in a case where the first cluster is cluster 1, cluster 2, cluster 3 and cluster 4 are the plurality of second clusters associated with cluster 1. Similarly, with respect to cluster 2, cluster 2 has an association relationship with cluster 1 and cluster 4, so in a case where the first cluster is cluster 2, cluster 1 and cluster 4 are the plurality of second clusters associated with cluster 2.

Furthermore, the access permission policy of the first cluster is acquired; wherein the access permission policy is a policy of an interactive access permission for node resources between a plurality of clusters. By taking a kubernetes cluster as an example, in one kubernetes cluster, each node pod has an independent IP address, and according to the service scenario, the pods between a plurality of kubernetes clusters may access each other to achieve data interaction. Generally, during the data interaction, with respect to one cluster, it is often required to manage the access permissions of the other clusters that are allowed (or prohibited) to access and/or allowed (or prohibited) to be accessed, that is, to set the access permission policy of the first cluster.

Furthermore, the step of acquiring an access permission policy of a first cluster comprises: acquiring configuration information of the first cluster; determining cluster information of the one or more second clusters associated with the first cluster in accordance with the configuration information; acquiring preset access permission information between the first cluster and the one or more second clusters, and generating the access permission policy of the first cluster based on the preset access permission information. Wherein, the cluster information of the respective second clusters associated with the first cluster may be determined by means of the acquired configuration information of the first cluster. For example, the first cluster is kubernetes cluster 1, the configuration file kubeconfig of kubernetes cluster 1 itself is acquired, and the configuration files kubeconfig corresponding to a plurality of other clusters associated with kubernetes cluster 1 are acquired.

With respect to the first cluster, the respective second clusters associated with the first cluster may be parsed by means of the configuration file of the first cluster itself and the configuration files of the other clusters. For example, it is parsed that kubernetes cluster 1 has communication connection and data interaction with kubernetes cluster 2 and kubernetes cluster 3, so it is determined that the second clusters associated with the first cluster kubernetes cluster 1 include kubernetes cluster 2, kubernetes cluster 3, and so on. Furthermore, preset access permission information between the first cluster and the one or more second clusters is acquired, and the access permission policy of the first cluster is generated based on the preset access permission information. Wherein, the preset access permission information may be obtained by parsing from the configuration file configured by the R&D personnel for the first cluster, and/or obtained by parsing from the custom permission data of the first cluster. Specifically, the access permission information may include: an access direction: accessing other clusters or being accessed by other clusters (Ingress and/or Egress), an IP address segment allowed for access set with respect to the access direction (including one or more port numbers associated with the IP address), or an IP address segment prohibited for access (including one or more port numbers associated with the IP address), a resource identifier allowed (or prohibited) for access (such as a namespace identifier, a node resource identifier, etc.), a communication protocol used for access, a node type, a node role, a node whitelist, and so on. The preset configuration file may be a file including various types of access permission information (such as a text file, a database file, etc.). Furthermore, the custom permission data included in the first cluster is obtained based on extension of native permission data of the cluster. By taking the kubernetes cluster as an example, the custom permission data may be obtained based on extension of the native NetworkPolicy configuration of the kubernetes cluster. For example, the custom permission data NewNpSpec of the CRD (CustomResourceDefinition) type is set, and NewNpSpec is obtained by extending NpSpec, wherein NpSpec is the native permission data. The specific information of the native permission data is set in v1.NetworkPolicy. For example, the following may be set in v1.NetworkPolicy: which IP+Port corresponding nodes may be accessed by the one or more pods in the Egress direction, or by which IP+Port corresponding nodes the one or more pods may be accessed in the Ingress direction. The data examples of NewNpSpec obtained by extending NpSpec are shown as follows:
type NewNpSpec struct{//NewNpSpec represents custom permission data
ClusterList []string ‘json:“clusterlist . . . ”’ //ClusterList represents a list of a plurality of clusters, and the specific list data may be acquired from the data in the json format;
NpSpec v1.NetworkPolicy ‘json:“npspec . . . ”’ /NpSpec represents native permission data, and the specific permission data may be acquired from the data in the json format}

That is, the step of acquiring preset access permission information between the first cluster and the one or more second clusters comprises: parsing the preset access permission information from a preset configuration file, and/or parsing the preset access permission information from custom permission data included in the first cluster, wherein the custom permission data is obtained based on extension of native permission data of the cluster.

Furthermore, the access permission policy of the first cluster is generated based on the preset access permission information. It may be understood that the access permission policy includes specific access permission information.

Step S102: updating, in a case where it is monitored that resources of any of the associated second clusters have changed, the access permission information corresponding to the second cluster that is included in the access permission policy in accordance with a change result of the resources of the second cluster.

Specifically, a controller (such as controller1) included in the first cluster may be used to monitor according to a set rule (such as set time intervals, service triggers, etc.) whether the resources of the one or more second clusters associated with the first cluster have changed, wherein the cases where the resources have changed are, for example, an node resource addition, a node resource update, a node resource deletion, a namespace resource change, and so on. In a case where it is determined that a change has occurred, the access permission information associated with the change result is updated in accordance with the change result of the change, that is, the access permission information corresponding to the second cluster that is included in the associated access permission policy is updated. For example, cluster 1 monitors that cluster 2 has deleted node 1, and node 1 is a node prohibited to be accessed by cluster 1 in the access permission information, so the access permission information may be updated correspondingly (for example, the access permission information with respect to node 1 is deleted). By taking the kubernetes cluster as an example, after it is monitored that the resources of any one or more second clusters have changed, an ipBlock field (the IP address segment included in the access permission information) of Ingress or Egress (access direction) in the NetworkPolicy associated with the first cluster may be dynamically filtered and updated in accordance with the access permission information defined in the custom permission data, thereby achieving the technical effect of updating the access permission information corresponding to the second cluster that is included in the access permission policy.

Furthermore, the first cluster monitors the case where the resources of any of the associated second cluster have changed, and/or monitors a resource change of the first cluster itself, that is, the first cluster monitors a change of the respective resources (such as a namespace resource, a node resource, etc.) included in the first cluster itself. Specifically, a controller (such as controller2) included in the first cluster may be used to monitor according to a set rule (such as set time intervals, service triggers, etc.) a resource change associated with the first cluster, in a case where it is determined that a change has occurred, the access permission information associated with the change result is updated in accordance with the change result of the change, and the controller manages the access permission between the first cluster and the second cluster associated therewith by using the updated access permission policy. That is, in a case where it is monitored that resources of the first cluster have changed, the access permission information corresponding to the first cluster that is included in the access permission policy is updated in accordance with a change result of the resources of the first cluster; the access permission between the first cluster and the second cluster associated therewith is managed by using the updated access permission policy.

Further preferably, the step of updating the access permission information corresponding to the second cluster that is included in the access permission policy comprises: adding an annotation including a cluster identifier of the second cluster to the access permission information corresponding to the second cluster; indicating a case where the resources of the second cluster have changed by means of the cluster identifier included in the annotation, so as to limit the access permission of the first cluster to access the second cluster by combining the access permission policy with the annotation in a case where the first cluster accesses the second cluster. Specifically, when the access permission information corresponding to the second cluster that is included in the access permission policy is updated for the first cluster, an annotation may be added to identify the second cluster to which a resource change has occurred, or the first cluster itself; wherein, for example, the second cluster is cluster 2, the cluster identifier is “cluster 2”, and then an annotation in the key-value format with respect to “cluster 2” may be added; for example, the key is newnpfrom, and the value is cluster 2. Similarly, in a case where it is required to update the access permission information included in the access permission policy with respect to the resource change of the first cluster itself, an annotation in the key-value format may be added; for example, the key is newnpfrom, and the value is the cluster identifier of the first cluster, such as cluster 1. It may be understood that by combining the access permission policy with the added annotation, a historical record of updating the access permission policy of the first cluster due to the resource changes of the first cluster and any of the one or more second clusters associated with the first cluster may be acquired; the accuracy and efficiency of managing an access permission policy are improved.

Step S103: managing the access permission between the first cluster and the second cluster associated therewith by using the updated access permission policy.

Specifically, the first cluster manages the access permission between the first cluster and the second cluster associated therewith by using the access permission policy. For example, by taking the kubernetes cluster as an example, the following may be set in v1.NetworkPolicy included in the access permission policy: which IP+Port corresponding nodes (that is, access permission) may be accessed by the one or more pods in the Egress direction, or by which IP+Port corresponding nodes (that is, access permission) the one or more pods may be accessed in the Ingress direction. Furthermore, the first cluster may interact with a business server apiserver included in the cluster by means of the access permission policy, and access a corresponding data layer by means of a network plug-in (such as calico, kube-router, cilium, etc.) to achieve management of an access permission.

As shown in FIG. 3, the embodiments of the disclosure provide a method for managing a cluster access permission, which method may comprise the following steps:

Step S301: initializing a permission controller corresponding to the cluster, and acquiring configuration information.

Specifically, the first cluster includes a permission controller. It may be understood that each of the plurality of clusters managed by the embodiments of the method of the disclosure includes a permission controller. That is, the first cluster includes a permission controller; the steps of acquiring the access permission policy of the first cluster and updating the access permission policy are performed by using the permission controller.

Furthermore, a permission controller npcontroller may be installed and deployed for each cluster. The permission controller npcontroller may run in any node server of the cluster to which it belongs, or may run in a server independent of the respective clusters.

Preferably, configuration information of the first cluster may be acquired during the initialization phase by using the npcontroller. The configuration information includes, for example, a first cluster configuration file (such as the kubeconfig file of the first cluster) and a second cluster configuration file (such as the kubeconfig file of the second cluster) of the other clusters managed (including one or more second clusters). Meanwhile, the permission controller is also used to interact with the apiservers of the plurality of clusters.

Furthermore, the step of updating the access policy may be performed by using the permission controller npcontroller in a case where it is monitored that the resources of any of the second clusters have changed.

Step S302: monitoring a resource change of the first cluster by using the first controller. Specifically, a first controller and a second controller are started for the first cluster to which the permission controller belongs by using the permission controller.

Step S303: monitoring a resource change of the one or more second clusters associated with the first cluster by using the second controller.

That is, a first controller and a second controller are started for the first cluster to which the permission controller belongs by using the permission controller; a resource change of the first cluster is monitored by using the first controller; a resource change of the one or more second clusters associated with the first cluster is monitored by using the second controller.

Wherein, the order of step S302 and step S303 is only exemplary, and the operations of step S302 and step S303 may be performed in any order, or may be performed simultaneously.

Step S304: updating the access permission information corresponding to the second cluster that is included in the access permission policy in accordance with a change result of the resources of the second cluster.

That is, the steps of acquiring the access permission policy of the first cluster and updating the access permission policy after monitoring the resource change of the second cluster are performed by using the permission controller.

The data layer may use a plug-in (such as calico, kube-router, cilium, etc.) to dynamically monitor a change to the NetworkPolicy resources of this cluster (i.e., the first cluster) by the npcontroller, and automatically issue a corresponding data layer rule to achieve management of a cluster access permission at a data level in accordance with the data layer rule.

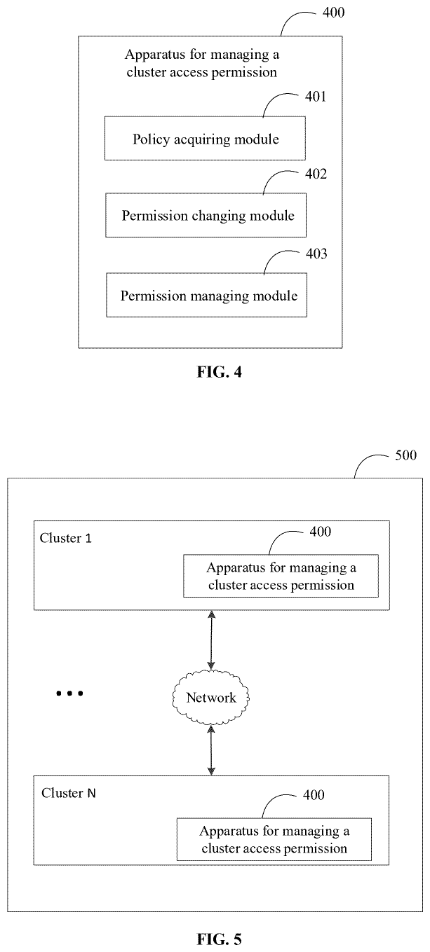

As shown in FIG. 4, the embodiments of the disclosure provide an apparatus 400 for managing a cluster access permission, comprising a policy acquiring module 401, a permission changing module 402 and a permission managing module 403; wherein,
the policy acquiring module 401 is used for acquiring an access permission policy of a first cluster; the access permission policy including access permission information between the first cluster and one or more second clusters associated therewith;
the permission changing module 402 is used for updating, in a case where it is monitored that resources of any of the associated second clusters have changed, the access permission information corresponding to the second cluster that is included in the access permission policy in accordance with a change result of the resources of the second cluster;
the permission managing module 403 is used for managing the access permission between the first cluster and the second cluster associated therewith by using the updated access permission policy.

In the embodiments of the disclosure, the permission changing module 402 updates, in a case where it is monitored that resources of the first cluster have changed, the access permission information corresponding to the first cluster that is included in the access permission policy in accordance with a change result of the resources of the first cluster; the permission managing module 403 manages the access permission between the first cluster and the second cluster associated therewith by using the updated access permission policy.

As shown in FIG. 5, the embodiments of the disclosure provide a system 500 for managing a cluster access permission, comprising: a plurality of communicatively connected clusters; wherein the apparatus 400 for managing a cluster access permission is configured in the one or more clusters;
wherein the permission changing module 402 included in the apparatus 400 for managing a cluster access permission is used for updating, in a case where it is monitored that resources of any of the associated second clusters have changed, the access permission information corresponding to the second cluster that is included in the access permission policy in accordance with a change result of the resources of the second cluster; or is used for updating, in a case where it is monitored that resources of the first cluster have changed, the access permission information corresponding to the first cluster that is included in the access permission policy in accordance with a change result of the resources of the first cluster.

The embodiments of the disclosure provide an electronic device for managing a cluster access permission, comprising: one or more processors; a storage device for storing one or more programs, the one or more programs, when executed by the one or more processors, causing the one or more processors to implement the method provided by any of the aforesaid embodiments.

The embodiments of the disclosure provide a computer-readable medium, on which a computer program is stored, the program, when executed by a processor, implementing the method provided by any of the aforesaid embodiments.

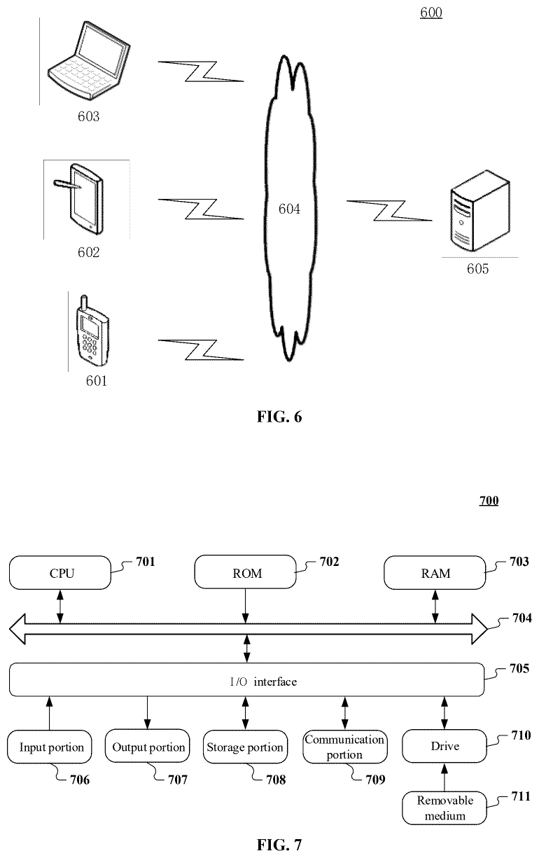

FIG. 6 shows an exemplary system architecture 600 to which a method for managing a cluster access permission or an apparatus for managing a cluster access permission according to the embodiments of the disclosure can be applied.

As shown in FIG. 6, the system architecture 600 may comprise terminal devices 601, 602 and 603, a network 604, and a server 605. The network 604 is a medium for providing a communication link between the terminal devices 601, 602 and 603 and the server 605. The network 604 may include various connection types, such as wired or wireless communication links, or fiber-optic cables.

The user may use the terminal devices 601, 602 and 603 to interact with the server 605 through the network 604 to receive or transmit messages and so on. Various client applications, such as electronic shopping mall client applications, web browser applications, search applications, instant messaging tools, email clients, and so on, may be installed on the terminal devices 601, 602 and 603.

The terminal devices 601, 602 and 603 may be various electronic devices having screens and supporting various client applications, including but not limited to smart phones, tablet computers, laptop portable computers, desktop computers, and so on.

The sever 605 may be a server that provides various services, such as a background management server that provides support for client applications used by the user using the terminal devices 601, 602 and 603. The cluster may include one or more servers 605; the background management server may process a received service request and feed service data back to the terminal devices.

It shall be noted that the method for managing a cluster access permission provided by the embodiments of the disclosure is generally performed by the server 605, and correspondingly, the apparatus for managing a cluster access permission is generally provided in the server 605.

It should be understood that the numbers of the terminal devices, the networks, and the servers in FIG. 6 are merely schematic. According to implementation requirements, there may be any numbers of terminal devices, networks, and servers.

Reference is now made to FIG. 7, which shows a schematic diagram of a structure of a computer system 700 suitable for implementing a terminal device according to an embodiment of the disclosure. The terminal device shown in FIG. 7 is only an example, and shall not impose any limitation on the functions and the scope of use of the embodiment of the disclosure.

As shown in FIG. 7, the computer system 700 includes a central processing unit (CPU) 701, which may perform various appropriate actions and processes according to a program stored in a read-only memory (ROM) 702 or a program loaded from a storage portion 708 into a random access memory (RAM) 703. Various programs and data required for the operation of the system 700 are also stored in the RAM 703. The CPU 701, the ROM 702 and the RAM 703 are connected to each other through a bus 704. An input/output (I/O) interface 705 is also connected to the bus 704.

The following components are connected to the I/O interface 705: an input portion 706 including a keyboard, a mouse, and so on; an output portion 707 including a cathode ray tube (CRT), a liquid crystal display (LCD) and so on, and a speaker and so on; a storage portion 708 including a hard disk and so on; and a communication portion 709 including a network interface card such as a LAN card, a modem, and so on. The communication portion 709 performs communication processing via a network such as the Internet. A drive 710 is also connected to the I/O interface 705 according to requirements. A removable medium 711, such as a magnetic disk, an optical disk, a magneto-optical disk, a semiconductor memory, and so on, is installed on the drive 710 according to requirements so that a computer program read therefrom is installed in the storage portion 708 according to requirements.

In particular, according to the embodiments of the disclosure, the process described above with reference to the flowchart may be implemented as a computer software program. For example, the embodiments of the disclosure include a computer program product, which includes a computer program carried on a computer-readable medium, the computer program containing a program code for performing the method shown in the flowchart. In such embodiment, the computer program may be downloaded and installed from the network through the communication portion 709, and/or installed from the removable medium 711. When the computer program is executed by the central processing unit (CPU) 701, the aforesaid functions defined in the system according to the disclosure are executed.

It shall be noted that the computer-readable medium shown in the disclosure may be a computer-readable signal medium or a computer-readable storage medium or any combination of the aforesaid two media. The computer-readable storage medium may be, for example, but not limited to, an electronic, magnetic, optical, electromagnetic, infrared, or semiconductor system, apparatus or device, or any combination thereof. More specific examples of the computer-readable storage medium may include, but are not limited to, an electrical connection with one or more wires, a portable computer disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination thereof. In the disclosure, the computer-readable storage medium may be any tangible medium containing or storing a program, and the program may be used by or in combination with an instruction execution system, apparatus or device. In the disclosure, the computer-readable signal medium may include a data signal propagated in a baseband or propagated as a part of a carrier wave, in which a computer-readable program code is carried. Such propagated data signal may adopt many forms, including but not limited to electromagnetic signals, optical signals, or any suitable combination thereof. The computer-readable signal medium may also be any computer-readable medium other than the computer-readable storage medium, and the computer-readable medium may send, propagate, or transmit a program for use by or in connection with the instruction execution system, apparatus or device. The program code contained on the computer-readable medium may be transmitted using any appropriate medium, including but not limited to wireless, wire, optical cable, RF, and so on, or any suitable combination thereof.

The flowcharts and block diagrams in the figures illustrate architectures, functions and operations that may be implemented by systems, methods and computer program products according to various embodiments of the disclosure. In this regard, each block in the flowcharts or block diagrams may represent a module, a program segment, or a part of a code, which contains one or more executable instructions for implementing specified logic functions. It shall also be noted that in some alternative implementations, the functions labeled in the blocks may also occur in an order different from that labeled in the figures. For example, two successively represented blocks may actually be executed substantially in parallel, and they may sometimes be executed in a reverse order, which depends on the functions involved. It shall also be noted that each block in the block diagrams or flowcharts, and combinations of the blocks in the block diagrams or flowcharts may be implemented with a dedicated hardware-based system that performs specified functions or operations, or may be implemented with a combination of dedicated hardware and computer instructions.

The involved modules and/or units described in the embodiments of the disclosure may be implemented by software or hardware. The described modules and/or units may also be provided in a processor. For example, a description may be made as follows: a processor comprising a policy acquiring module, a permission changing module and a permission managing module. The names of these modules do not form limitations of the modules themselves in some cases. For example, the policy acquiring module may also be described as “a module for acquiring an access permission policy of a first cluster”.

As another aspect, the disclosure also provides a computer-readable medium, which may be included in the devices described in the aforesaid embodiments, or may exist independently without being assembled into the devices. The aforesaid computer-readable medium carries one or more programs, and the one or more programs, when executed by one of the devices, cause the device to comprise: acquiring an access permission policy of a first cluster; the access permission policy including access permission information between the first cluster and one or more second clusters associated therewith; updating, in a case where it is monitored that resources of any of the associated second clusters have changed, the access permission information corresponding to the second cluster that is included in the access permission policy in accordance with a change result of the resources of the second cluster; managing the access permission between the first cluster and the second cluster associated therewith by using the updated access permission policy.

The embodiments of the disclosure are capable of automatically acquiring an access permission policy of a first cluster managed in a plurality of clusters; and acquiring access permission information between the first cluster and one or more second clusters associated therewith that is included in the access permission policy; automatically updating, in a case where it is monitored that resources of the one or more second clusters have changed, the access permission information included in the access permission policy; dynamically managing the plurality of clusters by using the updated access permission information. The method of the embodiments of the disclosure overcomes the problem of a comparatively poor flexibility in managing a cluster access permission in the existing method, and improves the real-time performance and efficiency of managing a cluster access permission.

The aforesaid specific implementation schemes do not form limitations on the scope of protection of the disclosure. It shall be understood by those skilled in the art that various modifications, combinations, sub-combinations and substitutions may occur depending on design requirements and other factors. Any modification, equivalent replacement, improvement, and so on made within the spirit and principle of the disclosure shall be included in the scope of protection of the disclosure.

1.-12. (canceled)

13. A method for managing a cluster access permission, comprising:
acquiring an access permission policy of a first cluster; the access permission policy including access permission information between the first cluster and one or more second clusters associated therewith;
updating, in a case where it is monitored that resources of any of the associated second clusters have changed, the access permission information corresponding to the second cluster that is included in the access permission policy in accordance with a change result of the resources of the second cluster;
managing the access permission between the first cluster and the second cluster associated therewith by using the updated access permission policy.

14. The method of claim 13, further comprising:
updating, in a case where it is monitored that resources of the first cluster have changed, the access permission information corresponding to the first cluster that is included in the access permission policy in accordance with a change result of the resources of the first cluster;
managing the access permission between the first cluster and the second cluster associated therewith by using the updated access permission policy.

15. The method of claim 13, wherein
the step of updating the access permission information corresponding to the second cluster that is included in the access permission policy comprises:
adding an annotation including a cluster identifier of the second cluster to the access permission information corresponding to the second cluster; indicating a case where the resources of the second cluster have changed by means of the cluster identifier included in the annotation, so as to limit the access permission of the first cluster to access the second cluster by combining the access permission policy with the annotation in a case where the first cluster accesses the second cluster.

16. The method of claim 13, wherein
the step of acquiring an access permission policy of a first cluster comprises:
acquiring configuration information of the first cluster; determining cluster information of the one or more second clusters associated with the first cluster in accordance with the configuration information;
acquiring preset access permission information between the first cluster and the one or more second clusters, and generating the access permission policy of the first cluster based on the preset access permission information.

17. The method of claim 16, wherein
the step of acquiring preset access permission information between the first cluster and the one or more second clusters comprises:
parsing the preset access permission information from a preset configuration file, and/or
parsing the preset access permission information from custom permission data included in the first cluster, wherein the custom permission data is obtained based on extension of native permission data of the cluster.

18. The method of claim 13, further comprising:
the first cluster including a permission controller;
performing the steps of acquiring the access permission policy of the first cluster and updating the access permission policy by using the permission controller.

19. The method of claim 18, further comprising:
starting a first controller and a second controller for the first cluster to which the permission controller belongs by using the permission controller;
monitoring a resource change of the first cluster by using the first controller;
monitoring a resource change of the one or more second clusters associated with the first cluster by using the second controller.

20. A system for managing a cluster access permission, the system comprising:
an apparatus including:
at least one processor; and
at least one memory operably connectable to the at least one processor, and storing instructions of performing operations when executed by the at least one processor, comprising:
acquiring an access permission policy of a first cluster; the access permission policy including access permission information between the first cluster and one or more second clusters associated therewith;
updating, in a case where it is monitored that resources of any of the associated second clusters have changed, the access permission information corresponding to the second cluster that is included in the access permission policy in accordance with a change result of the resources of the second cluster;
managing the access permission between the first cluster and the second cluster associated therewith by using the updated access permission policy.

21. The system of claim 20, the instructions further comprising:
updating, in a case where it is monitored that resources of the first cluster have changed, the access permission information corresponding to the first cluster that is included in the access permission policy in accordance with a change result of the resources of the first cluster;
managing the access permission between the first cluster and the second cluster associated therewith by using the updated access permission policy.

22. The system of claim 20, further comprising: a plurality of communicatively connected clusters; wherein the apparatus is configured in the plurality of communicatively connected clusters.

23. A non-transitory computer-readable medium, on which a computer program is stored, the computer program, when executed by a processor, implementing operations comprising:
acquiring an access permission policy of a first cluster; the access permission policy including access permission information between the first cluster and one or more second clusters associated therewith;
updating, in a case where it is monitored that resources of any of the associated second clusters have changed, the access permission information corresponding to the second cluster that is included in the access permission policy in accordance with a change result of the resources of the second cluster;
managing the access permission between the first cluster and the second cluster associated therewith by using the updated access permission policy.
